(19) United States
(12) Patent Application Publication
(10) Pub. No.: US 2002/0023009 A1
(43) Pub. Date: Feb. 21, 2002

(54) Method of giving gifts via online network

(76) Inventor: Fumiko Ikeda, Osaka-fu (JP)

Correspondence Address: MERCHANT & GOULD P.C., P.O. Box 2903, Minneapolis, MN, 55402-0903, US

(21) Appl. No.: 09/803,733

(22) Filed: Jul. 9, 2001

(30) Foreign Application Priority Data
Mar. 10, 2000 (JP) 2000-067824
Mar. 10, 2000 (JP) 2000-067825
Mar. 10, 2000 (JP) 2000-067828
Mar. 21, 2000 (JP) 2000-077657
Mar. 21, 2000 (JP) 2000-077658
Apr. 19, 2000 (JP) 2000-117377

(51) Int. Cl. G06F 17/60

(52) U.S. Cl. 705/26

(57) ABSTRACT

The present invention provides a method of giving gifted goods utilizing communication networks in which gift senders or gift recipients register information on gift recipients related to gift recipients in the server of gift dealers handling gifts. Gift dealers handling gifts provide the information on preferable goods related to preferable gifted goods to gift senders based on the information on gift recipients. Gift senders select and give gifted goods to gift recipients based on the information on gift recipients. Based on the information on gift senders and gift recipients or the messages exchanged by users in the virtual space, the virtual stores are prepared, and by giving the gifted goods in the virtual space, the gifts are given in reality.

### FIELD OF THE INVENTION

The present invention relates to a method of giving gifts by which the wants and favorites of gift recipients can be given via online networks, a method of giving gifts via online networks utilizing the virtual space, and a method of selling gifts via online networks.

### DESCRIPTION OF THE PRIOR ART

Heretofore, in sending gifted goods, gift senders used to give gifts assuming the goods which gift recipients would like to have or gift recipients like based on the conversation in the past with the said gift recipients. In addition, in order not to disturb gift recipients by sending them what they do not want to have, the gift senders cannot help but send safe gifts.

In addition, as the number of users utilizing the communication networks including internet increases recently, such methods as utilizing communication networks are employed in giving gifted goods as well.

However, in the conventional methods, gift senders cannot give the goods or favorite goods that gift recipients truly want to have without confirming gift recipients. In addition, even if gift senders know the hobbies or favorites of the gift recipients, unless gift senders know the details in the field, they cannot give the most suitable gifted goods to gift recipients.

Therefore, the object of the present invention is to provide a method of giving gifts via online networks wherein gift senders can send the gifted goods by selecting such goods based on the registered information of gift senders or gift recipients in the system of giving gifted goods by utilizing communication networks.

Further, the other object of the present invention is to provide a method of giving gifts via online wherein gift senders and gift recipients jointly own the virtual space utilizing the communication networks and the symbols defined for each user in the said virtual space.

### SUMMARY OF THE INVENTION

As a result of intensive studies, the present invention adopted a method of giving gifts via online networks by utilizing communication networks wherein the gift senders select and give gifted goods to gift recipients referring to the preferable goods information on preferable gifted goods for gift recipients as selected information provided by gift dealers handling gifts based on the information on gift recipients registered either by gift senders or gift recipients.

Therefore, in the present invention, since gift senders can select gifted goods based on the information registered by gift recipients him/herself, gift senders can give goods which gift recipients would like to have or gift recipients like. Therefore, without asking what kind of goods gift recipients would like to have, gift senders can select and give gifted goods obtaining the latest information on wants and favorites of the said gift recipients. Therefore, gift senders can give gift recipients gifted goods which the said gift recipients would like to have or gift recipients like without notice.

Since gift dealers handling gifts select preferred gifted goods for gift recipients based on the information on the said gift recipients when gift senders register information on gift recipients regarding gift recipients, gift senders can give the most suitable gifted goods for gift recipients without looking for several kinds of goods in order to give the most suitable gifts.

In addition, since gift senders can know what gift recipients would like to have or gift recipients like presently even though the gift senders have not had conversations with gift recipients recently, gift senders can give preferred goods for gift recipients when both parties cannot contact each other due to the busy schedule of gift recipients or long distance.

In particular, since communication networks are utilized, each user can select and give gifted goods what gift recipients would like to have or gift recipients like or the most suitable gifts by using the devices that can be connected to the communication networks (hereafter, it may be called the “network device”) either at home or any other places. Therefore, the user does not have to go to stores handling gifts. In addition, the user can order gifts at any time without worrying about the time.

In addition, since communication networks are used, the registered information on gift recipients can quickly be obtained. Further, gift dealers handling gifts provide information on preferable goods, or information on gifted goods preferable for gift recipients. Further, the gifted goods can be ordered quickly.

On the other hand, gift senders or gift recipients can register their information using communication networks. Therefore, registration by network device is possible without any geographical or time restriction.

In the method of giving gifts via online networks, it is preferable to include at least a piece of information selected from hobbies, wants, favorites, favorite colors or designs, recent schedules, anniversaries, family structures, sexual distinctions, ages, as registered information on gift recipients.

In particular, a method of giving gifts via online networks of the present invention, it is most preferable that gift dealers handling gifts provide gift senders preferred information on gifted goods selected based on the registered information of the said gift recipients before the anniversary of the gift recipients with the information on the said anniversary via e-mail. If the embodiment is so constructed, gift senders can obtain information on gifted goods preferred for gift recipients on their anniversary as well as their information on anniversary even though gift senders forget or are ignorant of the anniversary of gift recipients.

The present invention can adopt a method of giving gifts via online networks giving gifts by using communication networks wherein the users including at least one gift sender jointly own the virtual space and the symbols defined for each user in the said virtual space, and by exchanging messages in this virtual space, at least one gift senders among users select and give gifts to gift recipients.

Therefore, in the present invention, users can select and give gifted goods to gift recipients having conversations as if they met each other even though they do not meet in reality.

In the present invention, such a method of giving gifts via online network is preferable that at least a virtual store is provided in the virtual space and gift senders select and give gifts to gift recipients by utilizing the said virtual store. Thus, when the virtual space is provided on the screen of network device including computers and the like, gift senders can enjoy selecting gifts furthermore, since they can select gifts as if all the users as gift senders enjoyed shopping.

In particular, in the method of giving gifts via online networks of the present invention, it is preferable that at least one user among users including at least one gift sender is a gift recipient. In such an embodiment, it is in the same situation that gift senders and gift recipients do shopping together, which enables gift senders to give what gift recipients would like to have.

Various embodiments for use can be considered depending on the embodiment of users. For example, it is preferable that the number of users is two, and the said users love each other. When they love each other, even though they are apart in reality, one user can give gifted goods to the other user as if they met each other and enjoyed having a date.

It is also preferable that both users are a man and a woman who are doing omiai, an arranged meeting between an unmarried man and woman as the first step of arranging marriage in Japanese society. In particular, it is preferable to adopt a method of giving gifts via online networks wherein gift dealers handling gifts provide the information on the gifted goods preferable for one user to the other user based on the messages that have been exchanged. Thus, when the embodiment is so constructed that gift dealers handling gifts look for hobbies or favorites and the like for either party who is doing omiai, select the gifted goods suitable for him or her, and provide the information on gifted goods suitable for him or her to the other party, the gift sender, that is, the user with the information on gifted goods provided, can give such gifted goods that will please the gift recipient, that is, the user related to the said information on gifted goods, thereby enhancing the possibility of successful omiai.

The present invention can adopt a method of giving gifts via online networks wherein communication networks are utilized to give gifted goods when gift recipients and gift senders cannot connect to communication networks simultaneously or when gift senders do not know each other, the users jointly own the virtual space utilizing communication network and symbols defined for each user in the said virtual space, the said users at least select a group of gifted goods to be selected as favorite gifted goods in the said virtual space, gift dealers handling gifts send gift recipients storage media including the said information on a group of gifted goods, gift recipients, by using the said storage media, select the favorite gifted goods among a group of gifted goods and send the information on gifted goods to gift dealers handling gifts via communication networks, gift dealers handling gifts receive the information on gifted goods, and by sending the gifted goods related to the said information on gifted goods, gift senders, or the said users give gifted goods to gift recipients.

In such a method of the present invention, two users who are engaged can select the wedding reception hall, experiencing being in the virtual wedding reception hall which is the reproduction of the actual wedding reception hall and having conversations each other as if they met each other although they do not meet in reality. Likewise, they can select the presents as well.

In the present invention, at least the virtual wedding hall is provided in the virtual space and users can enter the inside of the said virtual wedding hall and experience being there.

On the other hand, gift recipients, or the attendance of the wedding ceremony, can find a group of gifted goods selected by gift senders, or bride and bridegroom by receiving a CD-ROM (hereafter, it may sometimes be called as a “catalog data CD”), setting the catalog data CD in the appropriate position of the computer, and thereby making the information on a group of gifted goods which is contained in the catalog data CD as data indicate on the screen of the computer. Then, gift recipients can select their favorite gifted goods among a group of gifted goods and receive their favorite gifted goods from the gift dealers handling gifts by sending the information on gifted goods to gift dealers handling gifts via network devices.

In particular, since a CD-ROM is used, more detailed information on goods can be obtained. For example, by selecting the appropriate position of indication of goods, with the selection method including clicking by a mouse, for example, the detailed explanation on the goods or images of the goods more easily and more quickly.

In addition, when the network device is used in indicating data of a CD-ROM, the order can be made by sending the information on the favorite gifted goods to the gift dealers handling gifts.

Therefore, gift recipients can select and order the gifted goods on the network devices.

When gift dealers handling gifts receive the order from the gift senders of sending the gifted goods via communication networks, gift dealers handling gifts can deliver the gifted goods to gift recipients, by containing the information on ordered group of gifted goods in CD-ROM as data, sending the catalog data CD to designated gift recipients, thereby informing gift recipients of the receipt of the order from gift senders. Then, when gift dealers handling gifts receive the information on the favorite gifted goods from gift senders, gift dealers handling gifts can deliver the gifted goods to gift recipients by sending the gifted goods to gift recipients.

In the present invention, it is preferable to adopt a method of giving gifts via online networks wherein at least a virtual store is provided in the virtual space and gift senders select and give the gifted goods to gift recipients by using the said virtual store. Thus, when the virtual store is provided on the screen of network devices including computers and the like, both users can enjoy selecting presents and gifted goods furthermore, because they can select presents as if they did shopping as a couple.

In addition, it is preferable to adopt a method of giving gifts via online networks of the present invention wherein the information on gift recipients is contained in a CD-ROM and the information on gift recipients is sent to gift dealers handling gifts with the information on gifted goods. Thus, when the information on gift recipients is contained in the catalog data CD as data, gift recipients do not have to put in their own information in ordering by sending the information on gifted goods to the gift dealers handling gifts. Therefore, it can save time and trouble of gift recipients drastically.

In the present invention, it is preferable to adopt a method of giving gifts via online networks of the present invention wherein sending information including e-mail address information on gift dealers handling gifts in a CD-ROM, and when data contained in a CD-ROM are displayed on the screen of the computer and favorite gifted goods are selected, e-mail including the information on gifted goods is sent to gift dealers handling gifts by this sending message utilizing communication networks. Thus, when the sending information including the information on e-mail address of gift dealers handling gifts is contained in the catalog data CD, gift recipients can send the information on their favorite gifted goods to gift dealers handling gifts only by selecting their favorite gifted goods. Thus, when the embodiment is constructed as above, it can save time and trouble of gift recipients further.

In addition, it is preferable to adopt a method of giving gifts via online networks of the present invention wherein message information, or a message from gift senders to gift recipients is contained in a CD-ROM. Thus, when message information is contained in a catalog data CD, a message from gift senders can be delivered to gift recipients.

The method related to this invention can also be applied for selling goods to users. That is, users can enjoy purchasing goods virtually experiencing various scenes as if they were there in the virtual space.

That is, the present invention can adopt a method of selling goods related to childbirth via online networks wherein a symbol defined for each user can purchase goods related to childbirth confirming goods at least necessary before and after childbirth by experiencing the process of childbirth including before and after childbirth.

Therefore, in the method of sales of the present invention, even though the user has not experienced childbirth, she can confirm goods at least necessary before and after childbirth by experiencing the process of childbirth as if she were experiencing childbirth process including before and after childbirth. Therefore, the user can purchase goods related to childbirth, while utilizing goods necessary before and after childbirth.

In the method of sales of the present invention, it is preferable that pregnant women or married couples of whom wives are pregnant are targeted as users. Since pregnant women or married couples of whom wives are pregnant are expecting childbirth, they are concerned about childbirth itself or are concerned about which goods to buy. Therefore, when a symbol defined for each experiences childbirth in the virtual space, virtually though, and when the pregnant women or married couples can select goods related to childbirth, the concern over childbirth itself as well as over the purchase of necessary goods upon childbirth can be reduced.

In the present invention, it is preferable to adopt such a method of selling goods related to childbirth via online networks that the virtual stores are provided in the virtual space, and users select and purchase goods related to childbirth utilizing the said virtual stores. Thus, when the virtual stores are provided on the screen of network devices including computers, or the like, users can enjoy selecting goods related to childbirth furthermore since they can select goods related to childbirth as if they did shopping as well as experiencing childbirth.

It is particularly preferable that dealers handling goods related to childbirth present the preferable goods related to childbirth to each user by selecting the preferable goods related to childbirth for each user based on the messages which users exchange each other. Thus, when the embodiment is so constructed that dealers handling goods related to childbirth provide the preferable information on goods related to childbirth by finding which goods users presently want from the conversation on which users are experiencing childbirth process and by selecting goods which users want, users who are provided information on goods related to childbirth can recognize the necessary goods related to childbirth easily even though they do not know which goods are necessary, since necessary goods are displayed. Therefore, the purchase of goods related to childbirth by users can be enhanced, making the sales of goods related to childbirth increase.

### BRIEF DESCRIPTION OF THE DRAWINGS

FIG. 1 is the figure showing the construction example of the chatting system that is used in the present invention.

FIG. 2 is the flow chart showing an example of the method of giving gifts via online networks of the present invention.

FIG. 3 is an example of the screen wherein users have conversation in the virtual space, until they enter a virtual stores in the method of giving gifts via online networks of the present invention.

FIG. 4 is an example of the screen wherein users have conversation in the virtual space, until they enter a virtual stores in the method of giving gifts via online networks of the present invention.

FIG. 5 is an example of the screen wherein users have conversation in the virtual space, until they enter a virtual stores in the method of giving gifts via online networks of the present invention.

FIG. 6 is an example of the screen wherein users give gifts in the virtual space in the method of giving gifts via online networks of the present invention.

FIG. 7 is an example of the screen wherein users settle the amount of gifts in the virtual space in the method of giving gifts via online networks of the present invention.

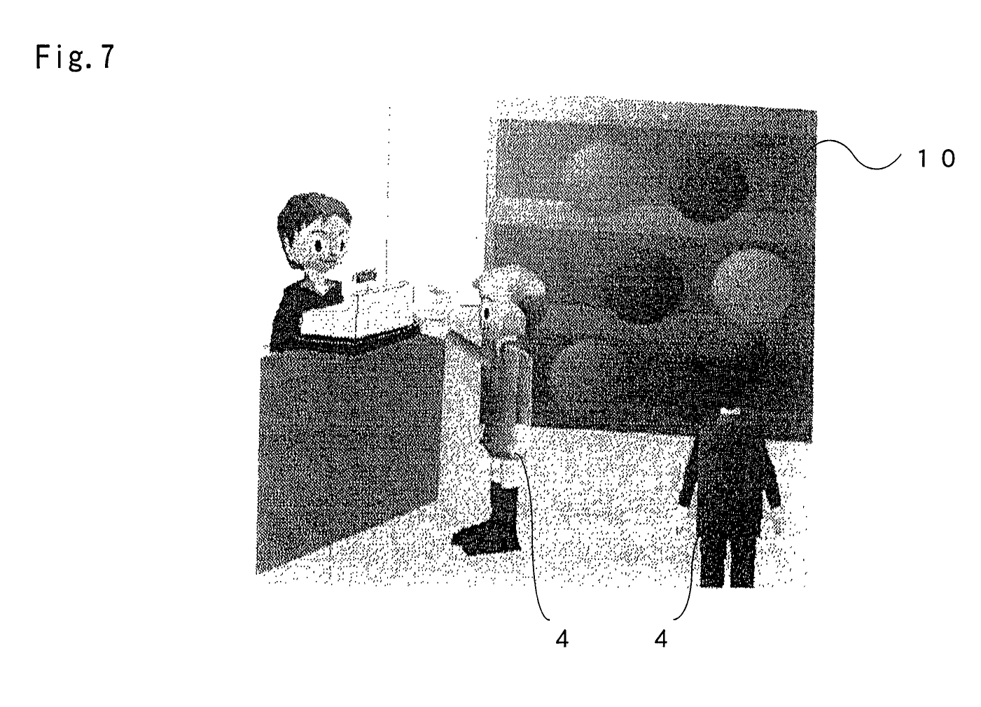

FIG. 8 is a flow chart showing one example of the method of giving gifts via online networks in the present invention.

FIG. 9 is a flow chart showing one example of the method of giving gifts via online networks in the present invention.

FIG. 10 is a flow chart showing one example of the method of selling products via online networks in the present invention.

### DESCRIPTION OF THE PREFERRED EMBODIMENT

Hereafter, the present invention is explained in detail based on the drawings.

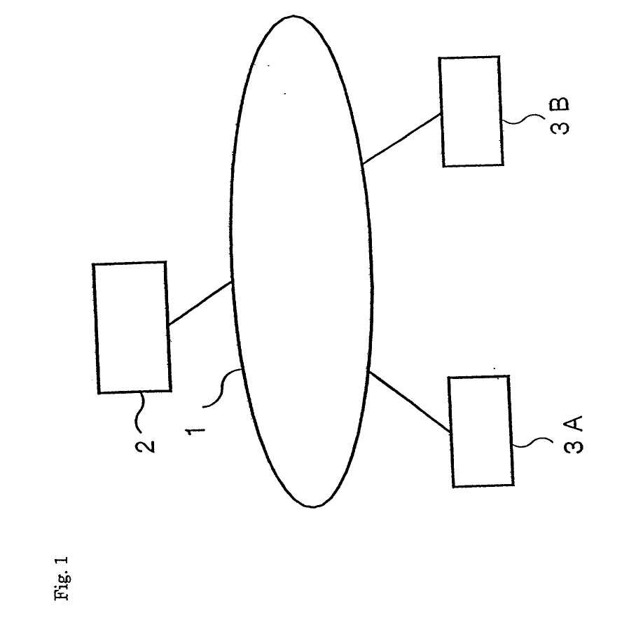

FIG. 1 is an example of network for realizing the method related to the present invention. In FIG. 1, 1 is a communication network, of which internet or intranet is preferable. 2 is a server, which in many cases, is operated by gift dealers handling gifts. 3A is a network device of gift senders, and 3B is a network device of gift recipients. As a network device, a personal computer is preferably used.

Gift senders or gift recipients can register names, addresses, telephone numbers, e-mail addresses, card information including credit cards, and the like, hobbies, what they want to have, favorites (including favorite goods, colors, or patterns), things they are interested in, recent schedules, anniversaries, family structures concerning gift recipients. The registered information is stored in server 2. It is preferable that the registration is conducted on e-mails or browser screens.

Gift senders can register names, addresses or residences, telephone numbers, e-mail addresses, card information including credit cards, and the like, concerning gift senders. Likewise, registered information is stored in server 2 and is used upon settlement or the like of the amounts for gifts.

In the present invention, when gift senders register themselves and gift recipients to whom gift senders want to send gifts register at the same time, the registered information of the said gift recipients can be used as data advice. That is, referring to the registered information of the said gift recipients, gift dealers handling gifts can propose preferable gifted goods to gift senders.

In the present invention, the registered information of the gift recipients can be taken in as related information for gift senders themselves. In other words, they can utilize the information as catalogs by their own.

Here, when the information on the gift recipients is registered, homepages for exclusive use of the said gift recipients may be prepared. Registered information can be changed on the home pages.

In the present invention, gift dealers handling gifts can propose gift senders recommended goods for the said gift recipients based on the registered information of gift recipients as selected information when the anniversaries of gift recipients approach. It is preferable that a method for proposal is delivered via e-mail. In addition, in the contents of e-mail, the URL of the home pages of the gift dealers handling gifts wherein the said recommended goods are described may be described as well, and the method of notifying the information when the specific software installed in the network devices of the gift recipients read the home pages specified voluntarily by the said URL.

As such recommended goods, by accumulating various kind of information, gift dealers handling gifts can propose preferable goods suitable for the said gift recipients can be proposed among abundant groups of goods.

As recommended goods, not only one goods, but also a group of goods consisting of several goods can be proposed. When a group of recommended goods is proposed as recommended goods, gift senders can select the most favorable goods for gift recipients among a group of favorable goods for gift recipients and the idea of gift senders themselves can be adopted in the gifted goods.

Further, users who are gift senders can apply for additional messages upon purchasing goods. In such an embodiment, by informing gift dealers handling gifts of the message to be attached to the goods by at least one user before the gift dealers send the said goods (for example, upon applying for goods), the gift senders can give the goods with messages to gift recipients.

Here, gift senders can select wrappings related to goods. In particular, when the registered items of gift recipients include their favorite colors, patterns, or the like, such an embodiment can be adopted that the wrappings related to the goods can be made suitable for gift recipients in terms of colors, patterns, or the like.

Further, when gift senders and gift recipients can connect to the communication networks at the same time, they can give and receive gifts by jointly owning the virtual space on the communication networks and experiencing various situations virtually.

The present invention adopts a message exchanging communication system including a so-called “chatting system” and the like where messages are exchanged among users. In such a message exchanging communication system, the virtual space can be provided. Therefore, by using the said message exchanging communication system, users can exchange messages in the virtual space and talk each other as if they met each other. Here, the chatting on the virtual space via communication networks can be realized by installing a software (including, community place (trade mark) manufactured by SONY Co., Ltd.) capable of displaying the virtual space described by VRML (Virtual Reality Modeling Languages) and the like in server for chatting 2, network device 3A, or the like.

In the system of purchasing gifts and settlement via online networks of the present invention, the users jointly own the virtual space by utilizing communication networks. This virtual space can be constructed two-dimensionally or three-dimensionally, depending on the visual viewpoint of users.

The virtual space is not specifically limited, and it may be any place in Japan or some other places in some foreign countries. Of course, since it is the virtual space, it may be the fictional space that does not exist in reality. For example, the virtual space may be the virtual town. It is preferable that the virtual shops or stores (they may hereafter be called “virtual stores” simply)are provided with the virtual town.

In addition, users jointly own the symbols of their own that are called “avatar(s)”, symbols defined for each user in the virtual space.

Each user can operate each avatar for him or her on the network device by his or her own. For example, each user can move his or her avatar to anywhere in the virtual space. Further, each user can make their avatars talk with characters or sounds. Users can make their avatars talk with sending character information or sound information.

Thus, in the virtual space, an avatar for each user can move and talk with characters or sounds, and users can talk by using their avatars. That is, users can talk each other as if they met each other.

It is preferable that users register in the method of giving gifts via online networks related to the present invention beforehand. Upon registration, types of avatars can be registered. Thus, by making registration beforehand, an avatar suitable for each user can be used. For example, when the user is a female, a feminine avatar can be used. Likewise, when the user is a male, a masculine avatar can be used. When the user has long hair, he or she can operate long-haired avatar. Since an avatar is a symbol of the user, to use such an avatar whose appearance is totally different from the user is possible. That is, the user can use an avatar as he or she likes.

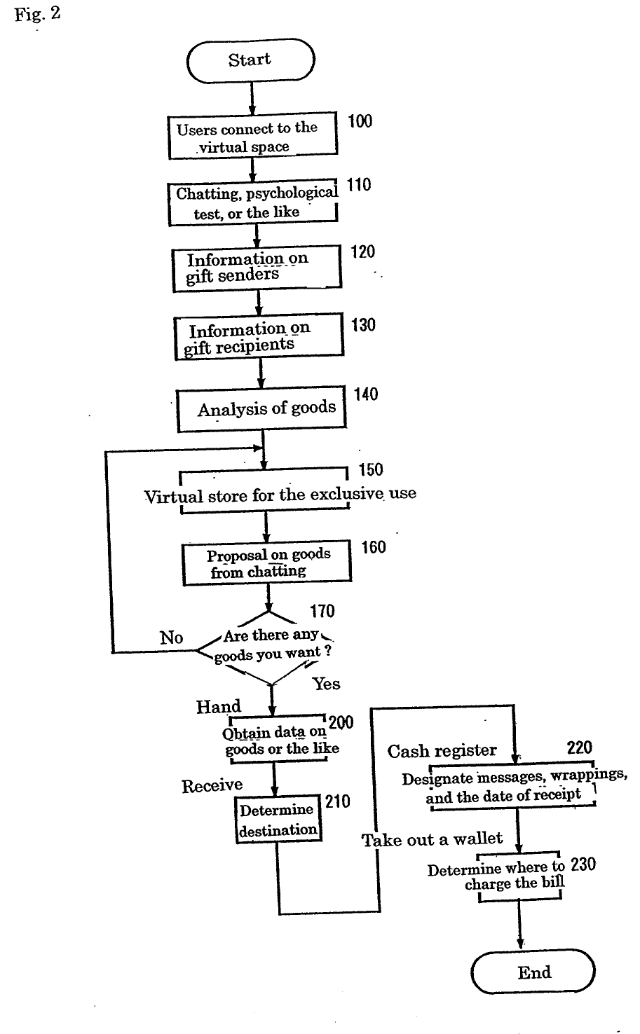

FIG. 2 is a flow chart showing that the couple are dating in the virtual space, where one of them gives gifts to the other. The attached numerals in FIG. 2 show each step. (Hereafter, the same applies in the flow charts.) In Step 100, users connect to the communication networks and two users loving each other meet in the virtual space which is jointly owned. In utilizing the method of giving gifts via online networks, a male user can use a masculine avatar and a female avatar can use a feminine avatar, thereby making two avatars loving each other in the virtual space. And by making these two avatars loving each other walk hand in hand in the virtual town as the virtual space, two users who love each other can experience the feeling of dating even though they do not meet in reality. Needless to say, they can experience the feeling of a kiss.

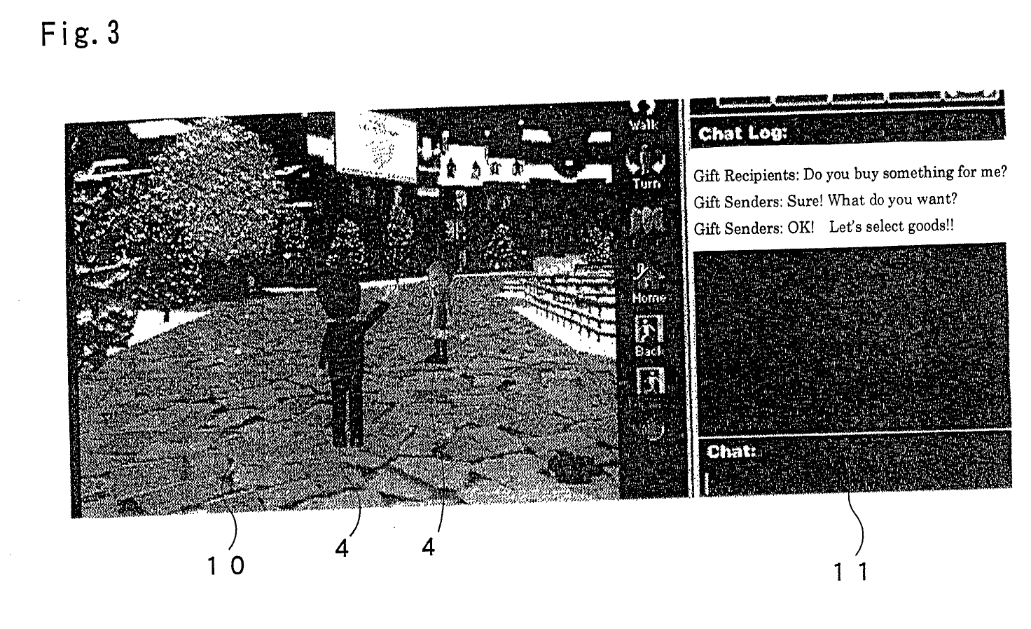

In Step 110, users can enjoy chatting, psychological tests, telling whether the couple are well matched, or the like. When they come across a virtual store in the virtual space, or when one of the users feel like giving gifts, they can enter the virtual store in the virtual space and give gifts. FIG. 3 shows that the avatar related to the gift sender enters the step of giving gifts in the virtual space. In FIG. 3, 10 is a screen showing the virtual space and 11 is a screen for chatting.

In Steps 120 and 130, information on each user is registered. Here, when the information on each user was already registered, this step can be omitted. As registration items, hobbies, favorites, anniversaries, wants, things he or she likes or is interested in and the like are preferable.

In Step 140, based on the user information on goods or stores suitable for gift recipients is found. Information on goods which is taken into account of the hobbies and favorites not only of gift recipients but also of gift senders is found.

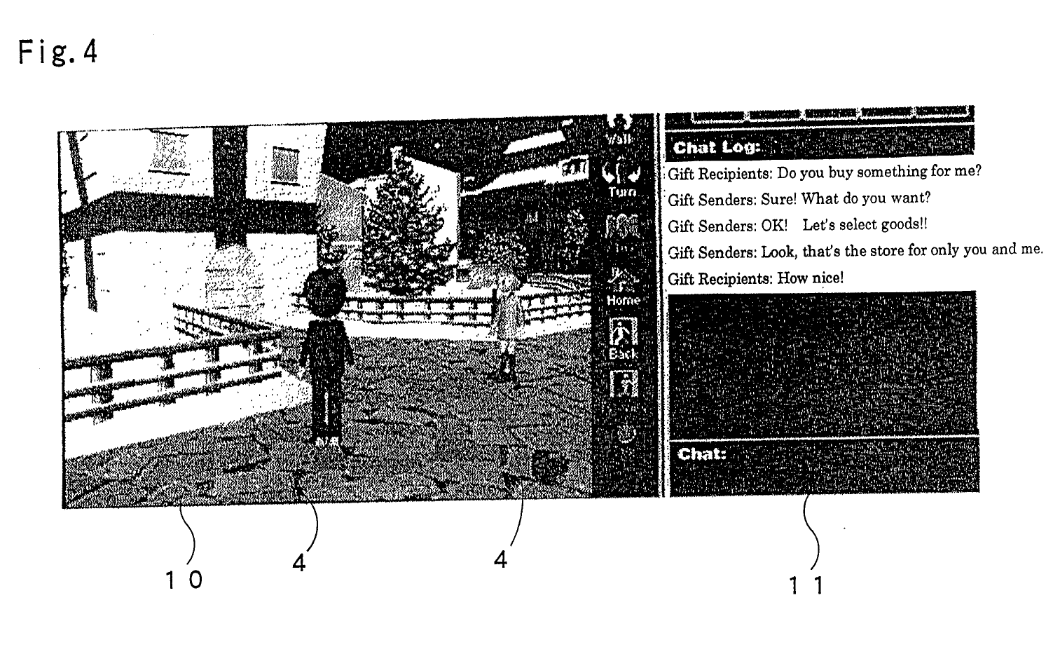

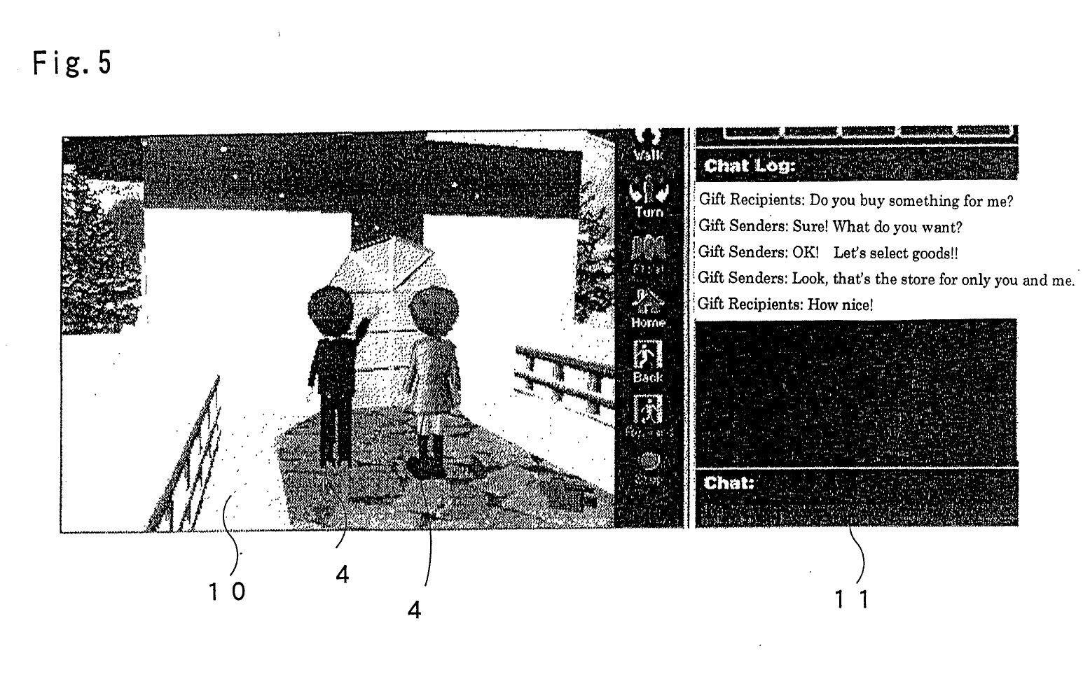

In Step 150, the virtual stores for the exclusive use of the said user are prepared and users can enter the virtual stores for their own. FIG. 4 shows that the virtual store is prepared for the exclusive use of gift senders and gift recipients. FIG. 5 shows that the gift senders and gift recipients enter the virtual stores for their own.

In Step 160, gift dealers handling gifts may indicate the stores suitable for users with priority or inform them of the recommended goods, recognizing the contents of exchanged messages in the virtual space. Or goods information obtained in Step 140 can be restricted or expanded.

Users may also indicate the stores suitable for other users with priority or inform them of the recommended goods by answering the questionnaires prepared by the gift dealers handling gifts on the home pages.

In the case where gift dealers handling gifts indicate the stores suitable for users with priority or inform them of the recommended goods, the data base of gift dealers handling gifts (including data base on goods, database on psychological test, or the like) can be used.

By adopting such embodiments as described so far, the embodiments can be so constructed that the users can instantly find the stores they like to enter.

As described above, it is preferable that the virtual space is provided with virtual stores. The types of virtual stores are not specifically limited and they can be stores handling a large variety of goods. In other words, it is preferable that the virtual stores are provided in the virtual town and a variety of goods is on sale therein.

Thus, in the virtual stores with the virtual town provided, when avatars loving each other enter the virtual stores, the initial screen turns to a screen showing the inside of the virtual stores, and the users can take a look at the virtual goods displayed in the virtual stores. Therefore, in Step 170, in the virtual stores, avatars loving each other can move, take the goods in their hand, have conversation each other over suitable goods and select the goods.

The embodiment can be so constructed that when an avatar takes the virtual goods in his or her hand, the specific indication about the goods (including explanation on goods by characters, sounds, photographs, moving pictures, or the like)appears. And when such goods as favorable to give or to be given are found, these avatars go to Step 200, where giving gifts in the virtual space is conducted. When such goods as favorable to give or to be given are not found, they go back to Step 150, resuming chatting thereby proposing preferable goods.

In Step 200 and thereafter, giving gifts in the virtual space is conducted depending on some movements by avatars. For example, the embodiment can be so constructed that a male user can give gifted goods to a female user when masculine avatar delivers the virtual goods to a feminine avatar and a feminine avatar receives the said goods.

To be specific, in Step 200, gift senders take goods which they want to send in their hand. At this stage, the data on goods are obtained.

In Step 210, virtual goods are handed from one avatar related to one user to the other avatar related to the other user. The avatar which was handed receives the virtual goods. At this stage, the designation of gifts (including the actual addresses of gift recipients, or the like) is specified.

In Step 220, the virtual goods are put in a shopping bag, put on the cash register, taken to the cash register, thereby making settlement. At this stage, the goods are decided and the amount of goods is presented.

Further, the embodiment is so constructed that the users related to gift senders can designate the wrappings related to the goods. In addition, the users related to gift senders can apply for attaching the additional messages upon purchase of the goods. In other words, the embodiment is conducted when the shop clerk, who is the avatar, asks on wrappings or messages and gift senders or gift recipients designate them. In reality, when users related to gift senders inform gift dealers handling gifts of messages to be attached to wrappings or goods before gift dealers handling gifts send the goods, gifted goods with messages attached and with designated wrappings can be given from gift senders to gift recipients.

In addition, when the shop clerk, who is the avatar, asks gift recipients the date of receipt and gift recipients answer it, the actual date of receipt can be designated. When designation is over, the shop clerk presents the total amount due.

In Step 230, when gift senders agree to the presented total amount, the avatars for gift senders show a movement of taking a wallet. By this movement, the method of settlement or designation for the bill is determined. Lastly, when gift recipients receive goods from the shop clerk, the transaction is completed.

In reality, the embodiment is that when gift senders handling gifts charge the amount of goods to the user who takes a wallet and send goods to the user who was handed goods, the gift-giving from gift senders to gift recipients is made. Needless to say, the goods sent from gift senders to gift recipients are not virtual goods, but real goods.

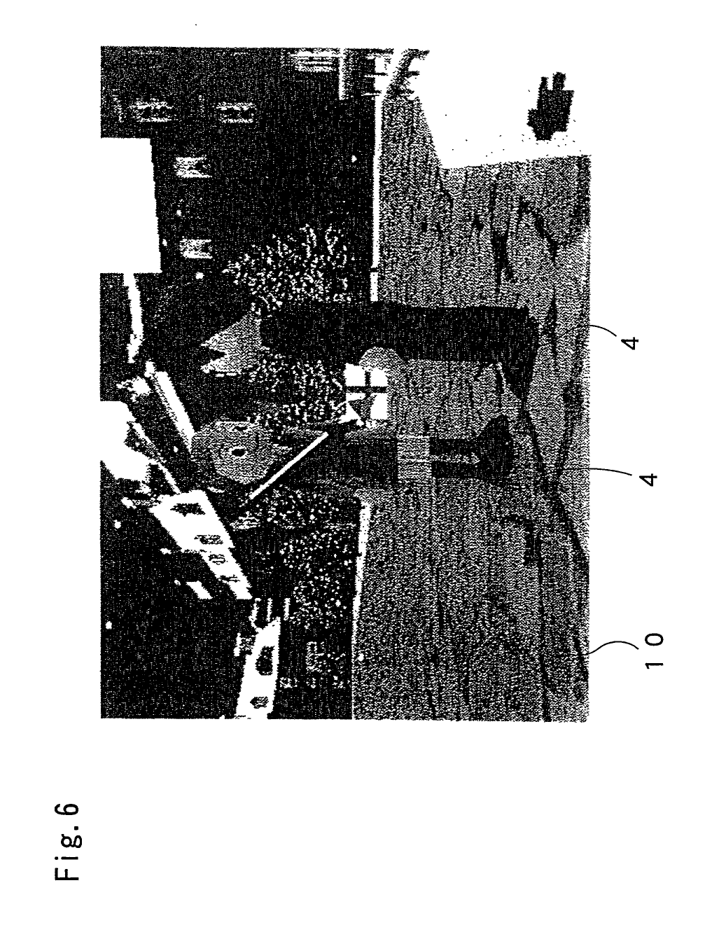

FIG. 6 shows the situation where the avatar related to the gift sender gives gifts to the avatar related to the gift recipient in Step 210.

FIG. 6 shows the situation where the settlement is conducted at the cash register in the virtual store (Step 220).

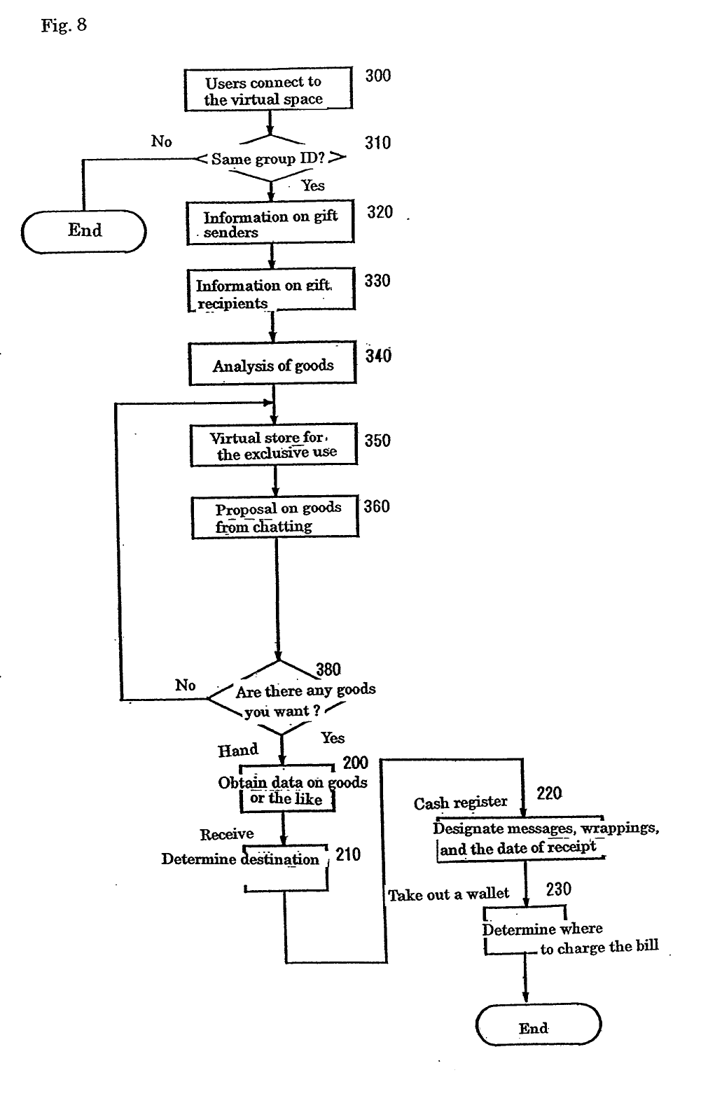

FIG. 8 is a flow chart where giving gifts is conducted in an omiai, not in a date. Step 300 is the same as Step 100 in that users are connected to communication networks.

In Step 310, it is confirmed that the men and women doing an omiai have the same group IDs. Steps 320 to 340 are like Steps 120 to 140, where preferable information on goods is found based on the hobbies, preferences, or anniversaries of the men and women doing an omiai.

In Step 350, as in Step 150, preferable information on goods for the said men and women is found recognizing the contents of exchanged messages in the virtual space. In addition, virtual stores including fortune telling houses to tell whether the couple are well matched may be provided, whose result may be considered for reference. When preferable information on goods is found, the goods in the virtual stores for the exclusive use of the said users are limited or expanded.

In Step 380, as in Step 170, users enter the virtual stores to confirm whether there are favorable goods. When what they want to give or to be given is found, they go to Step 200, where the gift-giving is conducted. When what they want to give or to be given is not found, they go back to Step 350, resuming chatting and the preferable goods are proposed.

Explanation is omitted as for Step 200 and thereafter since they are the same as those steps explained in FIG. 2. Thus, the method of giving gifts via online networks of the present invention is preferably applied for giving gifts between men and women doing omiai.

Further, gift dealers handling gifts can select preferable gifted goods for each user based on the exchanged messages. Upon selecting preferable gifted goods for some users, by utilizing data accumulated by gift dealers handling gifts, information on preferable goods for them can be further ensured.

In particular, this information on gifted goods can be provided to other users. For example, when the information on preferable gifted goods on a female user is provided to a male user, the male user can give gifted goods which would please the female user based on the said information. Therefore, the possibility of a successful omiai is enhanced. Further, for gift dealers handling gifts, it has a merit since gifted goods sells. Therefore, it has a merit not only for users but also for gift dealers handling gifts.

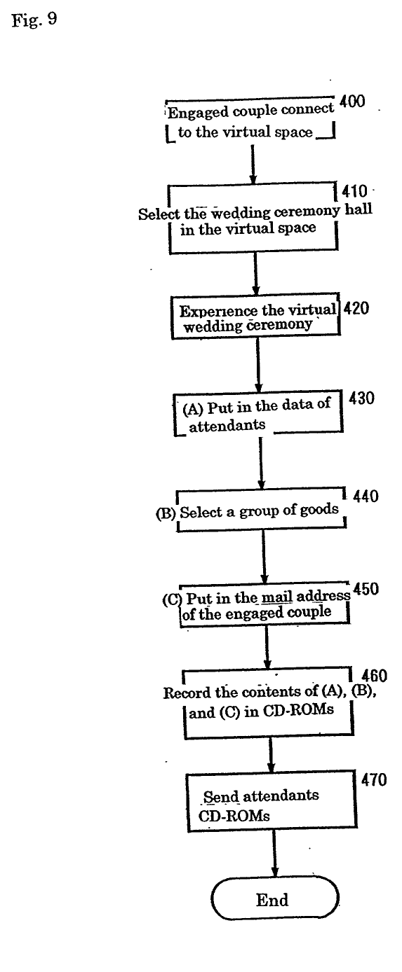

Even though the gift recipients are not connected to communication networks, such a method can be adopted that gift senders designate a group of preferable goods and gift recipients select goods they want among the said group of goods. FIG. 9 is a flow chart showing that the engaged couple select for a ceremonial hall for wedding and give presents to attendance. Therefore, the engaged couple are gift senders and the attendance is a gift recipient.

In the present invention, as described above, it is preferable that the users (the engaged couple) register the information. By registration, home pages for exclusive use of the users may be prepared. Thus, when the home pages for exclusive use of the users are provided, the virtual space can effectively be utilized.

Upon registration, information on each user (including names, addresses or residences, e-mail addresses, card information including credit cards and the like) can be registered.

In Step 400, the engaged couple jointly own the virtual space via communication networks. It is preferable that the ceremony hall for wedding is provided in this virtual space. When two avatars related to users who are a couple enter the virtual ceremony hall for wedding (Step 410), the screen turns into the screen in the virtual ceremony hall for wedding and the couple can select the ceremony hall for wedding, experiencing the wedding ceremony in this virtual ceremony hall for wedding (Step 420). In the virtual experience, depending on the preference, detailed arrangements decoration, music, dishes, and the like can be specified and the wedding ceremony can be experienced.

In Step 430 and thereafter, after virtually experiencing the wedding ceremony or the like, the avatars related to the engaged couple select the presents. In Step 430, the information on attendance (including ages, sexual distinction, hobbies, preferences, or the like) is put in. Of course, it can be put in beforehand.

In Step 440, a group of preferable goods for the said attendance are selected. The embodiment can be so constructed that the avatars related to the couple enter the virtual stores in the case the virtual stores are provided in a virtual space and users can take a look at the virtual goods displayed in the virtual stores.

In the virtual stores, avatars for the engaged couple can move, take the goods in their hand, have conversation over what goods they want and select goods. Or they can select goods by clicking their preferable goods on the screen on which the list or the picture of a group of goods is displayed.

Here, in the method of the present invention, gift dealers handing gifts can propose preferable recommended goods as presents depending on the types of the wedding. As for such recommended goods, by accumulating various kinds of data, gift dealers handing gifts can propose preferable goods suitable for the person among abundant groups of goods.

As for recommended goods, not only one goods but also a group of goods can be proposed. When a recommended group of goods are proposed as recommended goods, gift senders can select a kind of/kinds of goods favorable for gift recipients and the idea of gift senders can be taken in selecting the gifted goods.

Here, in the present invention, it is preferable to adopt such a method that gift senders let gift recipients select gifted goods favorable for gift recipients among several kinds of gifted goods already selected by gift senders. In other words, it is preferable that the gift senders select a group of gifted goods and let gift recipients select gifted goods favorable for gift recipients.

Such information can be contained as information on gift recipients (names, addresses, telephone numbers, and e-mail addresses) or sending information (including information on e-mail addresses of gift dealers handling gifts, or the like) in addition to information on a group of gifted goods (Step 450).

In Step 460, mass-storage media including CD-ROMs (others include CD-Rs, CD-RWs, MOs, and the like) where at least information on a group of goods selected by gift senders, information on gift recipients, and sending information are registered.

When receiving the order of a group of gifted goods from gift senders, gift dealers handling gifts send the CD-ROMs including information on a group of gifted goods to gift recipients (Step 470). The embodiment may be the one that the CD-ROMs are handed to gift recipients at the time of the wedding.

Further, gift senders can apply for additional messages upon purchasing goods. In such an embodiment, by informing gift dealers handling gifts of the message to be attached to the goods by gift senders before the gift dealers send the said goods, the gift senders can give the CD-ROM with messages to gift recipients.

Gift recipients can select their favorite goods among a group of goods selected by gift senders by reading the contents of the said CD-ROM by personal computers, or the like.

When information on gift recipients is contained in CD-ROMs, gift recipients can reduce trouble since they need not inform gift dealers handling gifts of their names, addresses, or the like in sending the information of gifted goods on favorite gifted goods among a group of gifted goods to gift dealers handling gifts. Further, writing mistakes by gift recipients can be prevented.

On the other hand, gift dealers handling gifts never fail to receive the information on gift recipients.

In addition, when sending information including e-mail addresses information on gift dealers handling gifts in a CD-ROM, gift recipients can save trouble and avoid mistakes in sending information on gifted goods to gift dealers handling gifts. In other words, gift recipients select their favorite gifted goods among a group of gifted goods by setting the received CD-ROM in a prescribed place in the computer which is connected to communication networks and displaying the data of a group of gifted goods contained in a CD-ROM. In doing so, they have only to select the favorite gifted goods on the displayed screen by clicking with a mouse, or the like, and the information on the gifted goods can be sent to gift dealers handling gifts with the use of communication networks. In the said case, it is preferable that the information on gift recipients is contained in CD-ROMs.

Therefore, the engaged couple can decide presents for those who attend their wedding by selecting the ceremony hall for the wedding, looking for what they want to have together, and having conversation each other even though they are apart from each other.

Although a method of giving gifts via online networks have been stated so far, this can also be applied for the method of selling goods via online networks.

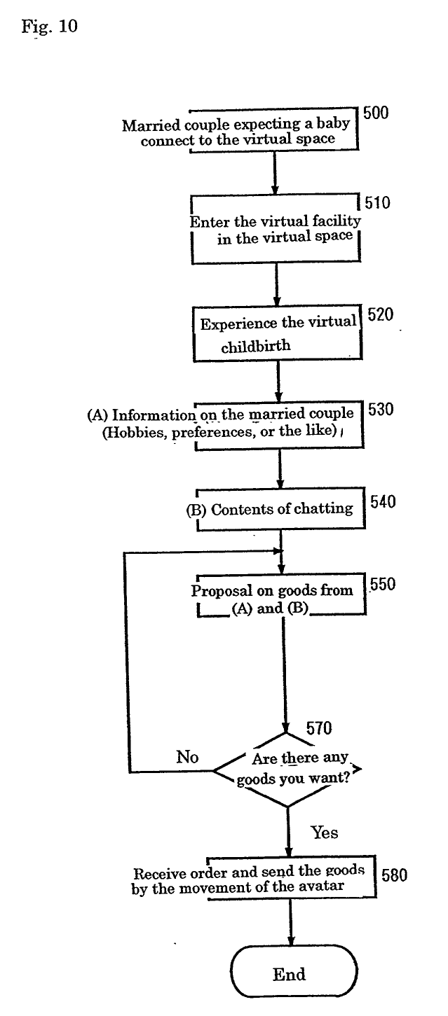

FIG. 10 is a flow chart in which a married couple who are expecting childbirth purchases goods related to childbirth experiencing various things virtually in the virtual space. In Step 500, the said married couple jointly own the virtual space via communication networks.

When a pregnant woman and her husband utilize the method of selling goods related to childbirth via online networks, experience of childbirth can be had by using an avatar looking like a pregnant woman for a pregnant user, and a masculine avatar for her husband. These two avatars can select and purchase goods related to childbirth in the virtual town as the virtual space.

In Step 510, the married couple enter a virtual facility (for example, an obstetrics and gynecology clinic, or the like) to experience the process of childbirth in the virtual space. In Step 520, although the process of childbirth to be experienced is not specifically limited, various situations ranging from after pregnancy to several years after childbirth are cited. To be specific, as for before childbirth, the situation of practicing Lamaze at home, the situation of beginning to labor, the situation of going to hospital, the situation just before childbirth, or the like can be cited.

In addition, as for after childbirth, the situation just after childbirth, the situation of child care at home, the situation of taking a walk with a baby, the situation of riding a car with a baby, or the like can be cited.

Here, users can practice Lamaze by watching the video indicating how to practice Lamaze instead of practicing Lamaze by the avatar.

Here, in the situation of experiencing after childbirth, an avatar looking like a baby is provided. The baby avatar is so constructed that either one user or all users can operate it. Further, the baby avatar is so constructed that users cannot operate it and is operated by a computer automatically.

Thus, by experiencing the process of childbirth, goods related to childbirth can be recognized. And goods necessary for childbirth can be purchased while experiencing the process of childbirth.

As for goods related to childbirth, underwear for babies, clothes for babies, socks for babies, hats for babies, blankets, bibs, baby bottles, teething rings, rattles, blankets for babies, dolls to be taken to the bath room, brushes for babies, combs for babies, spoons for babies, forks for babies, hand towels for babies, cups with lids for babies in cleaning their mouth, whistles, chamber pots, stuffed animals, picture books, child-care videos, baby-care videos, cases to preserve navel strings and/or teeth of babies, and the like can be cited.

While the goods are proposed during the process of virtual experience (Step 550), in Step 530, information on already registered married couples is refereed to, and in Step 540, preferable information on goods is proposed, referring to the contents of chatting during the process of virtual experience (Step 540), and taking account of goods which seemed necessary from the information on the married couples and the virtual experience, thereby proposing information on preferred goods. Information on registered married couples preferably include hobbies, preferences, anniversaries, what they want, or things they are interested in, favorite characters or brand names, animals, flowers, colors, or the like. In addition, the contents answering the questionnaire prepared by dealers handling goods related to childbirth may be taken into account. Further, the data base prepared by dealers handling goods related to childbirth (including data base on goods, data base on psychological tests and the like) may be utilized.

By adopting such an embodiment, the embodiment can be so constructed that users can find goods suitable for them instantly.

The goods are proposed by presenting the lists of goods or by displaying the photographs. When favorite goods are found and wanted for a purchase among the proposed goods, the avatar may try on the goods as well.

In Step 570, when the favorite goods are found, the avatar purchases them, and when the favorite goods are not found, it goes back to Step 550 and further selection of the goods is conducted.

In Step 580, with the movement of the avatars, the settlement of goods is conducted. In other words, the embodiment can be so constructed that in Step 570, the avatar representing a stork carries the virtual goods and the married couple purchase the goods when the avatars representing a married couple tell their will to purchase goods to a stork after they try on the said goods.

Users can adopt such a construction that the wrappings related to the goods can be specified.

Of course, the goods which dealers handling goods related to childbirth deliver to the users are real goods, not virtual goods.

For information, in Step 510, various kinds of virtual spaces can be provided. For example, the room for counseling by a doctor may be provided in the virtual space. In other words, when the avatar enters the room for counseling by a doctor, the screen turns to the screen displaying the room of a doctor where the virtual character representing a doctor is. Then the embodiment is so constructed that when the avatar asks several questions for the doctor's advice, the virtual character representing a doctor answers these questions.

Further, when the photograph of a married couple are sent to the computer (server, in particular) related to the system utilizing the method of the present invention, the faces of avatars can be made to be very like or identical to the married couple.

In particular, when the photograph of a married couple is sent to the computer (server, in particular) related to the system utilizing the method of the present invention, such a service can be adopted that the composite photograph of their future baby imagined to be the child between the married couple is displayed. When such a service as displaying the composite photograph of their future baby is provided, the users who are the married couple feel more intimacy to childbirth, which leads to the promoted sales of goods related to childbirth.

As explained so far, in the method of giving gifts via online networks of the present invention, communication and sales are integrated. Therefore, even though the users are apart each other, they can decide goods for purchase by taking a look at what they want together and having conversations each other.

Here, the present invention includes the identical subject matter disclosed in the specification, claims of Japanese Patent applications 2000-067824, 2000-067825, 2000-067828, 2000-077657, 2000-077658, and 2000-117377 to which is claimed priority for the present application.

What is claimed is:

1. A method of giving gifts via online networks by utilizing communication networks wherein the gift senders select and give gifted goods to gift recipients referring to the preferable goods information on preferable gifted goods for gift recipients as selected information provided by gift dealers handling gifts based on the information on gift recipients registered either by gift senders or gift recipients.

2. A method of giving gifts via online networks as set forth in claim 1 wherein at least one information is contained in the registered information on gift recipients, selected from hobbies, wants, favorite goods, favorite colors or patterns, things they are interested in, recent schedules, anniversaries, family structures, sexual distinctions, and ages.

3. A method of giving gifts via online networks as set forth in claim 1 wherein gift dealers handling gifts provide gift recipients with preferable gifted goods information which is selected based on the registered information of the said gift recipients before the anniversaries of the gift recipients together with the information of the said anniversaries by using e-mail.

4. A method of giving gifts via online networks giving gifts by using communication networks wherein the users including at least one gift sender jointly own the virtual space and the symbols defined for each user in the said virtual space, and by exchanging messages in this virtual space, at least one gift senders among users select and give gifts to gift recipients.

5. A method of giving gifts via online networks as set forth in claim 4 wherein at least a virtual store is provided in the virtual space and gift senders select and give the gifted goods to gift recipients by using the said virtual store.

6. A method of giving gifts via online networks as set forth in claim 5 wherein gift dealers handling gifts select the preferable gifted goods for each user and provide the information on the gifted goods preferable for one user to the other user based on the messages that have been exchanged.

7. A method of giving gifts via online networks as set forth in claim 6 wherein at least one user among users is a gift recipient.

8. A method of giving gifts via online networks as set forth in claim 6 wherein the number of users is two.

9. A method of giving gifts via online networks as set forth in claim 6 wherein users love each other.

10. A method of giving gifts via online networks as set forth in claim 6 wherein users are doing omiai in the virtual space.

11. A method of giving gifts via online networks wherein communication networks are utilized to give gifted goods when users jointly own the virtual space utilizing communication network and symbols defined for each user in the said virtual space, the said users at least select a group of gifted goods to be selected as favorite gifted goods in the said virtual space, gift dealers handling gifts send gift recipients storage media including the said information on a group of gifted goods, gift recipients, by using the said storage media, select the favorite gifted goods among a group of gifted goods and send the information on gifted goods to gift dealers handling gifts via communication networks, gift dealers handling gifts receive the information on gifted goods, and by sending the gifted goods related to the said information on gifted goods, gift senders, or the said users give gifted goods to gift recipients.

12. A method of giving gifts via online networks wherein two engaged users at least select a group of gifted goods to let gift recipients or attendance at the wedding ceremony select their favorite gifted goods as presents, gift dealers handling gifts send gift recipients CD-ROMs containing the information on the said group of gifted goods as presents, gift recipients, by using the CD-ROMs, select the favorite gifted goods among a group of gifted goods and send the information on gifted goods to gift dealers handling gifts via communication networks, gift dealers handling gifts receive the information on gifted goods and by sending the gifted goods related to the information on the said gifted goods, gift senders, or the said users give gifted goods to gift recipients.

13. A method of giving gifts via online networks as set forth in claim 11 wherein at least a virtual store is provided in the virtual space and gift senders select and give the gifted goods to gift recipients by using the said virtual store.

14. A method of giving gifts via online networks as set forth in claim 11 wherein the information on gift recipients is contained in a CD-ROM and the information on gift recipients is sent to gift dealers handling gifts with the information on gifted goods.

15. A method of giving gifts via online networks as set forth in claim 11 wherein sending information including e-mail address information on gift dealers handling gifts in a CD-ROM, and when data contained in a CD-ROM are displayed on the screen of the computer and favorite gifted goods are selected, e-mail including the information on gifted goods is sent to gift dealers handling gifts by this sending message utilizing communication networks.

16. A method of giving gifts via online networks as set forth in claim 11 wherein message information, or a message from gift senders to gift recipients is contained in a CD-ROM.

17. A method of selling goods related to childbirth via online networks wherein a symbol defined for each user can purchase goods related to childbirth confirming goods at least necessary before and after childbirth by experiencing the process of childbirth including before and after childbirth.

18. A method of selling goods related to childbirth via online networks as set forth in claim 17 wherein pregnant women or married couples of whom wives are pregnant are targeted as users.

19. A method of selling goods related to childbirth via online networks as set forth in claim 17 wherein the virtual stores are provided in the virtual space, and users select and purchase goods related to childbirth utilizing the said virtual stores.

20. A method of selling goods related to childbirth via online networks as set forth in claim 17 wherein dealers handling goods related to childbirth present the preferable goods related to childbirth to each user by selecting the preferable goods related to childbirth for each user based on the messages which users exchange each other.
